(19) United States
(12) Patent Application Publication
(10) Pub. No.: US 2022/0048067 A1
(43) Pub. Date: Feb. 17, 2022

(54) RAPID CAULK TAPE SYSTEM AND METHOD

(71) Applicant: Mike Wold, Barrie (CA)

(72) Inventor: Mike Wold, Barrie (CA)

(21) Appl. No.: 17/512,517

(22) Filed: Oct. 27, 2021

Related U.S. Application Data
(63) Continuation-in-part of application No. 16/169,932, filed on Oct. 24, 2018, now abandoned.

(51) Int. Cl. B05D 1/32; C09J 7/38; C09J 7/40; E04F 21/165

(52) U.S. Cl. CPC B05D 1/325; C09J 7/38; C09J 7/403; E04F 21/1655; C09J 2301/204; C09J 2203/37; C09J 2301/302; C09J 2301/18; C09J 2301/16; E04F 21/1657

(57) ABSTRACT

The device is a tape having a pair of parallel perforated lines running lengthwise along the center of the tape having a pressure-sensitive adhesive coating on a bottom surface of said tape whereby the tape is comprised of three sections: a first adhesive section, a non-adhesive section and a second adhesive section, with the non-adhesive section defined by the perforated lines.

### INDEX TO RELATED APPLICATIONS

This application is a continuation in part of U.S. patent application Ser. No. 16/169,932, filed Oct. 24, 2018, disclosure of which is incorporated herein by reference in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of coating processes of existing art and more specifically relates to a rapid caulk tape system.

### SUMMARY OF THE INVENTION

In view of the foregoing disadvantages inherent in the known coating processes art, the present disclosure provides a novel rapid caulk tape system. The general purpose of the present disclosure, which will be described subsequently in greater detail, is to provide an efficient and effective rapid caulk tape system.

A rapid caulk tape system is disclosed herein comprising: a tape provided in rolls, the tape having a pair of parallel perforated lines running lengthwise along the center of the tape; and the tape having a pressure-sensitive adhesive coating on a bottom surface of said tape, the pressure-sensitive adhesive coating located between said perforated line and an exterior perimeter of said tape such that said tape is thereby comprised of three sections: a first adhesive section, a non-adhesive section and a second adhesive section, with the non-adhesive section defined by the perforated lines. The tape may further comprise a backing layer removably adhered to the pressure sensitive adhesive coating which is removed prior to use.

A method of use for the rapid caulk tape system is also disclosed herein, the method comprising the steps of: providing a rapid caulk tape system comprising a tape provided in rolls, the tape having a pair of parallel perforated lines running lengthwise along the center of the tape; and the tape having a pressure-sensitive adhesive coating on a bottom surface of said tape, the pressure-sensitive adhesive coating located between said perforated line and an exterior perimeter of said tape such that said tape is thereby comprised of three parallel sections: a first adhesive section, a non-adhesive section and a second adhesive section, with the non-adhesive section defined by the perforated lines; contouring the tape to a caulkable object; removing the non-adhesive section via the perforated lines before caulking is applied object and caulking the object. The method may further comprise the step of removing the tape via peeling leaving behind a straight and uniform line of caulk.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

In one embodiment the present invention is a rapid caulk tape system comprising:

a tape provided in rolls,
said tape being only a single layer having a pair of parallel perforated lines running lengthwise along the center of the tape and a crease formed along a center of the tape between said perforated lines to facilitate positioning of the tape in a wall corner;
a removable central section defined by said parallel perforated lines;
and
said tape having a pressure-sensitive adhesive coating on a bottom surface of said tape, the pressure-sensitive adhesive coating located between said perforated line and an exterior perimeter of said tape such that said tape is thereby comprised of three sections: a first adhesive section, a non-adhesive section and a second adhesive section, with said removable non-adhesive center section defined by the perforated lines.

In one embodiment, the tape has a release coating on a top surface such that the pressure sensitive adhesive on the bottom surface will releasably engage the release coating for manual separation of the tape when rolled upon itself.

In one embodiment, the crease is formed along a center of the tape between said perforated lines to facilitate positioning of the tape in a wall corner.

In one embodiment, the said tape further includes evenly spaced slits along at least one exterior edge, the slits running perpendicular to said crease, to facilitate positioning of the tape along a curved surface.

In one embodiment, the self-release properties of the pressure-sensitive adhesive of the tape is formulated to be able to peel away once caulk is added to an area exposed once a perforated removable center is removed.

In one embodiment, the tape, once peeled away after said caulk is added, leaves behind a straight and uniform line of said caulk.

In one embodiment, the perforated lines are punch-pierced.

In one embodiment, the rolls are sequentially wound with said tape.

In one embodiment, the tape further comprises a backing layer removable adhered to the pressure sensitive adhesive on the bottom surface, the backing layer being removed prior to use.

In one embodiment, the tape is able to be flexibly conformed to a wall corner.

In one embodiment, the wall corner a tile bath enclosure.

In one embodiment, the tape is a planar single layer when removed from said roll.

In one embodiment, the peel is provided via a manual-pull. of said perforated removable center

In one embodiment, the roll further includes a caulk smoothing tool removably attached to a starting end of said roll.

In one embodiment, the pressure-sensitive adhesive is run directly adjacent to said perforated lines.

In one embodiment, the invention is =a rapid caulk tape system comprising:

a tape provided in rolls,
said tape being only a single layer having a pair of parallel perforated lines running lengthwise along the center of the tape and a crease formed along a center of the tape between said perforated lines to facilitate positioning of the tape in a wall corner;
said tape having a pressure-sensitive adhesive coating on a bottom surface of said tape, the pressure-sensitive adhesive coating located between said perforated line and an exterior perimeter of said tape such that said tape is thereby comprised of three sections: a first adhesive section, a non-adhesive section and a second adhesive section, with the non-adhesive section defined by the perforated lines;
wherein the tape has a release coating on a top surface such that the pressure-sensitive adhesive on the bottom surface will releasably engage the release coating for manual separation of the tape when rolled upon itself;
wherein a crease is formed along a center of the tape to facilitate positioning of the tape in a wall corner;
wherein self-release properties of the pressure-sensitive adhesive of the tape is formulated to be able to peel away once the caulk is added to an area exposed once a perforated removable center is removed;
wherein the tape once peeled away leaves behind a straight and uniform line of the caulk;
wherein the rolls are sequentially wound with the tape;
wherein the pressure-sensitive adhesive comprises glue;
wherein the tape is able to be flexibly conformed to a caulkable object;
wherein the tape is substantially planar when removed from the roll; and
wherein the pressure-sensitive adhesive is run parallel and adjacent to the perforated lines.

In one embodiment, the invention is further comprising set of instructions; and

wherein the rapid caulk tape system is arranged as a kit.

The invention also includes a method of use for the rapid caulk tape system, the method comprising the steps of:

providing a rapid caulk tape system as described herein:
contouring said tape to a caulkable object or surface;
removing the non-adhesive center section via the perforated lines exposing a central area configured for receiving calking; and
caulking said exposed central area.

The method is further comprising the step of removing said tape via peeling leaving behind a straight and uniform line of caulk.

In one embodiment, the invention is a rapid caulk tape system consisting of:

a tape provided in rolls,
said tape being only a single layer having a pair of parallel perforated lines running lengthwise along the center of the tape and a crease formed along a center of the tape between said perforated lines to facilitate positioning of the tape in a wall corner;
said tape having a pressure-sensitive adhesive coating on a bottom surface of said tape, the pressure-sensitive adhesive coating located between said perforated line and an exterior perimeter of said tape such that said tape is thereby comprised of three sections: a first adhesive section, a non-adhesive section and a second adhesive section, with the non-adhesive section defined by the perforated lines;
wherein the tape has a release coating on a top surface such that the pressure-sensitive adhesive on the bottom surface will releasably engage the release coating for manual separation of the tape when rolled upon itself;
wherein a crease is formed along a center of the tape to facilitate positioning of the tape in a wall corner;
wherein self-release properties of the pressure-sensitive adhesive of the tape is formulated to be able to peel away once the caulk is added to an area exposed once a perforated removable center is removed;
wherein the tape once peeled away leaves behind a straight and uniform line of the caulk;
wherein the rolls are sequentially wound with the tape;
wherein the pressure-sensitive adhesive comprises glue;
wherein the tape is able to be flexibly conformed to a caulkable object;
wherein the tape is substantially planar when removed from the roll; and
wherein the pressure-sensitive adhesive is run parallel and adjacent to the perforated lines.

### BRIEF DESCRIPTION OF THE SEVERAL VIEWS OF THE DRAWINGS

The figures which accompany the written portion of this specification illustrate embodiments and methods of use for the present disclosure, a rapid caulk tape system, constructed and operative according to the teachings of the present disclosure.

FIG. 1 is a perspective view of the rapid caulk tape system during an ‘in-use’ condition, according to an embodiment of the disclosure.

FIG. 2 is a perspective view of preparation for use of caulking with the rapid caulk tape system of FIG. 1, according to an embodiment of the present disclosure.

FIG. 3 is a perspective view of the rapid caulk tape system of FIG. 1, according to an embodiment of the present disclosure.

FIG. 4 is a perspective view of the rapid caulk tape system of FIG. 1, according to an embodiment of the present disclosure.

FIG. 5 is a flow diagram illustrating a method of use for the rapid caulk tape system, according to an embodiment of the present disclosure.

FIG. 6 is a perspective view of the rapid caulk tape system, according to an embodiment of the present disclosure.

FIG. 7 is section view along section lines A-A from FIG. 6.

FIG. 8 is an exploded partial perspective view of the rapid caulk tape system, according to an embodiment of the present disclosure.

FIG. 9 is a partial perspective view of the rapid caulk tape system, according to an embodiment of the present disclosure.

FIG. 10 is a partial perspective view of the rapid caulk tape system demonstrating removal of the central section, according to an embodiment of the present disclosure

The various embodiments of the present invention will hereinafter be described in conjunction with the appended drawings, wherein like designations denote like elements.

### DETAILED DESCRIPTION

As discussed above, embodiments of the present disclosure relate to coating processes and more particularly to a rapid caulk tape system as used to improve the efficiency of caulking.

Generally, the present invention assists in rapid caulking of seams between adjacent materials (such as tile bath enclosures); a tape is provided in rolls. The tape having a pair of parallel perforated lines running lengthwise along the center of the tape; and the tape having a pressure-sensitive adhesive coating on a bottom surface of said tape, the pressure-sensitive adhesive coating located between said perforated line and an exterior perimeter of said tape such that said tape is thereby comprised of three sections: a first adhesive section, a non-adhesive section and a second adhesive section, with the non-adhesive section defined by the perforated lines. The tape has a release coating on a top surface such that the pressure-sensitive adhesive on the bottom surface will releasably engage the release coating for manual separation of the tape when rolled upon itself. A crease is formed along the center of the tape between the perforated line to facilitate positioning of the tape in a wall corner. The tape also has a perforated removable center to be removed before caulking is applied. The self-release properties of the tape's adhesive are formulated to be able to peel away once the caulk is added, leaving behind a straight and uniform line of caulk.

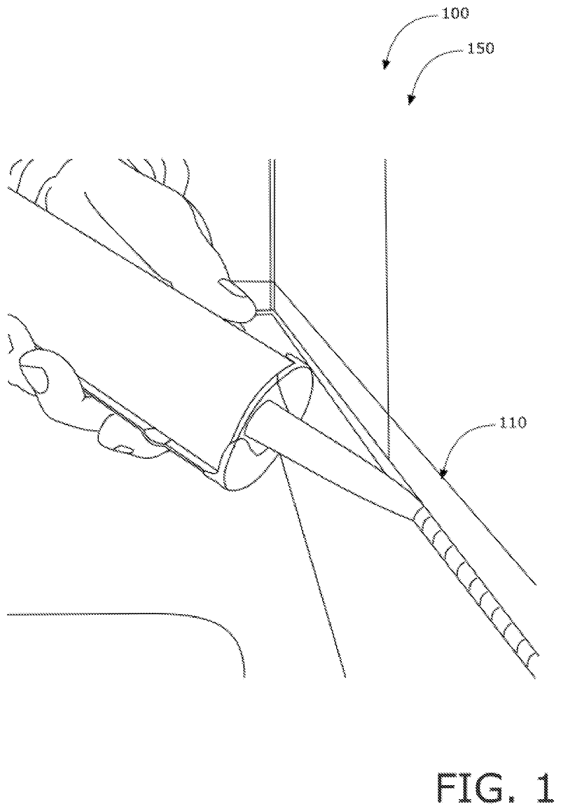

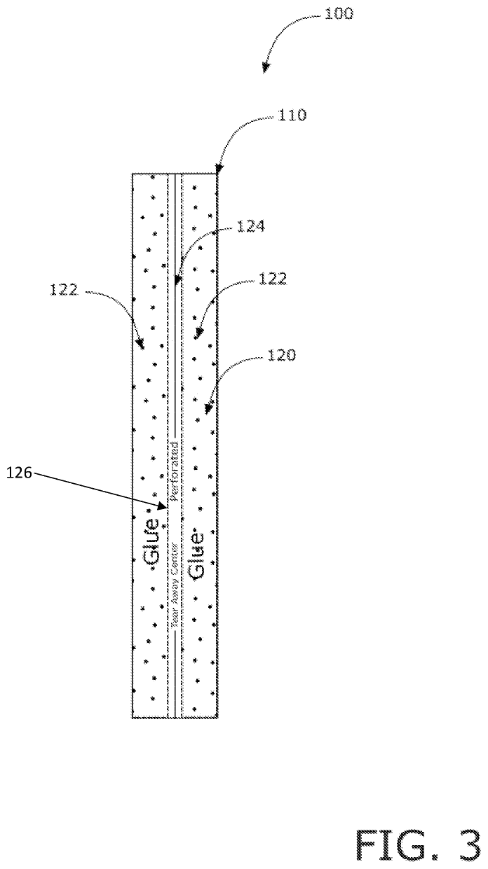

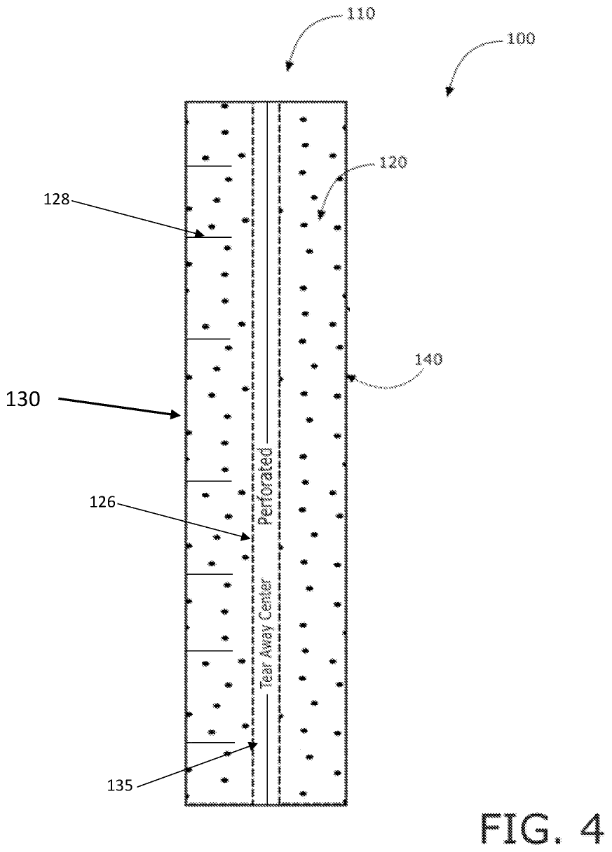

Referring now more specifically to the drawings by numerals of reference, there is shown in FIGS. 1-4, various views of a rapid caulk tape system 100.

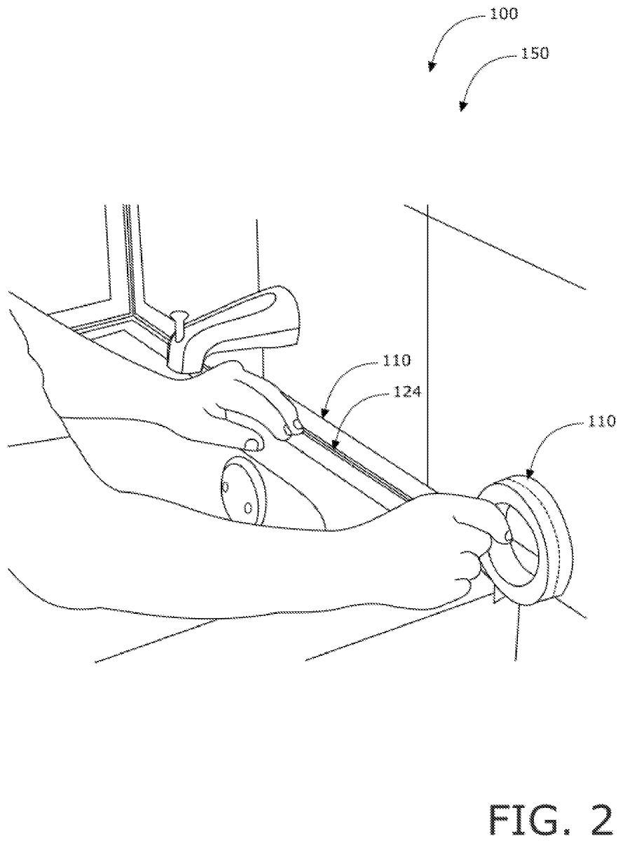

FIG. 1 shows a rapid caulk tape system 100 during an ‘in-use’ condition 150, during a caulking procedure, according to an embodiment of the present disclosure. FIG. 2 shows how the setup occurs for use of rapid caulk tape system 100. Here, the rapid caulk tape system 100 may be beneficial for use by a user to neatly and efficiently caulk items. As illustrated, the rapid caulk tape system 100 may include a tape 110 provided in rolls; the tape 110 having a layer 120 of flexible paper material with an inwardly facing pressure-sensitive adhesive 122 coating thereon; a pair of parallel perforated lines 126 running lengthwise along the center of the tape and a crease 124 running lengthwise between the perforated lines 126. Thus, the tape has a first adhesive section 130 and a second adhesive section 140 separated be a non-adhesive section 135 which is removable via tearing along the perforated lines 126. The tape may optionally include a backing strip which removably adheres to the pressure-sensitive adhesive 122 along the bottom/back of the tape 110. The backing strip prevents the tape from adhering to itself while in the roll and is removed by the user prior to placing the tape 110 on the surface being caulked.

According to one embodiment, the rapid caulk tape system 100 may be arranged as a kit. In particular, the rapid caulk tape system 100 may further include a set of instructions. The instructions may detail functional relationships in relation to the structure of the rapid caulk tape system 100 such that the rapid caulk tape system 100 can be used, maintained, or the like, in a preferred manner. The rapid caulk tape system 100 may further include a smoothing tool, either included in the kit, or removably attached to the start of the roll of tape 110. Alternatively, a section of tape may be folded and adhered to itself (with or without the backing, if present) to form a smoothing tool.

Referring now to FIGS. 2-4 showing various views of the rapid caulk tape system 100 of FIG. 1, according to an embodiment of the present disclosure.

The top surface of the tape 110 may have an outwardly facing release coating such that the pressure-sensitive adhesive 122 on the bottom surface of the tape 110 will releasably engage the top surface for manual separation of the tape 110 when rolled upon itself. A crease 124 is formed along a center of the tape 110 to facilitate positioning of the tape 110 in a wall corner. The tape 110 also preferably has a perforated removable center 135 to be removed before the caulking is applied. The self-release properties of the pressure-sensitive adhesive 122 of the tape 110 is formulated to be able to ‘peel’ away once the caulk is added. The tape 110 of the rapid caulk tape system 100 once peeled away leaves behind a straight and uniform line of the caulk (as laid in a bead). The perforated removable center is punch-pierced during manufacturing. The rolls are sequentially wound with the tape 110. To facilitate use in covering rounded or curved areas, the tape 110 may be further provided with slits 128 running perpendicular to the exterior edge of the tape 110.

Referring now to the pressure-sensitive adhesive 122; the pressure-sensitive adhesive 122 preferably comprises either glue or non-glue. The adhesive 122 should be at least partially hydrophilic to prevent caulk from flowing under the tape 110 once applied. Preferably, the adhesive 122 should be placed directly along the edge created by the perforated lines 126. On the exterior edge of the tape 110, the adhesive may run directly to the edge, or stop just prior to the exterior edge to provide a lip which may be gripped to assist in removing the tape 110. Upon reading this specification, it should be appreciated that, under appropriate circumstances, considering such issues as user preferences, design preference, structural requirements, marketing preferences, cost, available materials, technological advances, etc., other fastening means arrangements such as, for example, other adhesives, non-adhesives, etc., may be sufficient.

The tape 110 is able to be flexibly conformed to a caulkable object, wherein the caulkable object comprises a tile bath enclosure or the like for example. The tape 110 is planar when removed from the roll, as manually dispensed. The ‘peel’ (when tape 110 is removed) is provided via a manual-pull. The pressure-sensitive adhesive 122 is run parallel to the crease 124 and run adjacent to the crease 124. Preferably, the tape (and backing, if used) and adhesive is made from a non-toxic, biodegradable material, such as a heavy-duty unbleached paper or the like.

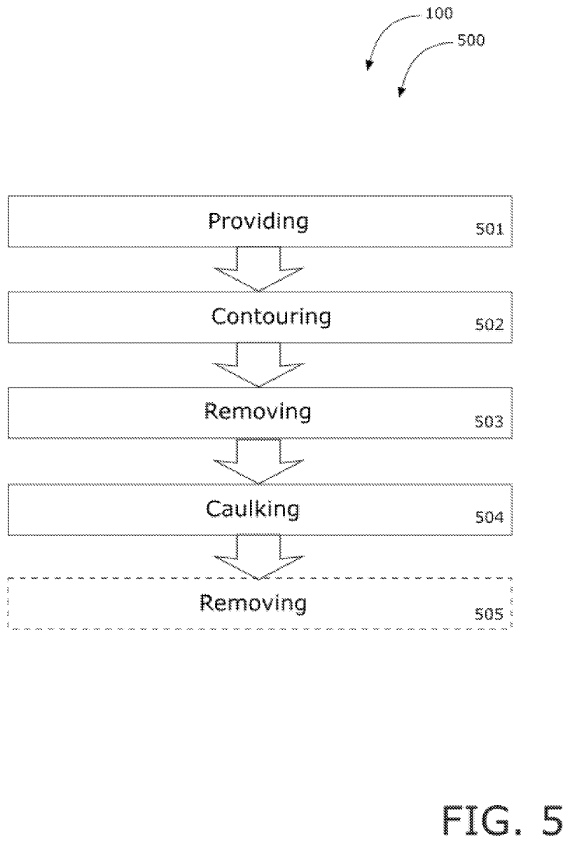

Referring now to FIG. 5 showing a flow diagram illustrating a method of use 500 for rapid caulk tape system 100, according to an embodiment of the present disclosure. In particular, the method of use 500 may include one or more components or features of the rapid caulk tape system 100 as described above. As illustrated, the method of use 500 may include the steps of: step one 501, providing a rapid caulk tape system comprising a tape provided in rolls, the tape having a pair of parallel perforated lines running lengthwise along the center of the tape; and the tape having a pressure-sensitive adhesive coating on a bottom surface of said tape, the pressure-sensitive adhesive coating located between said perforated line and an exterior perimeter of said tape such that said tape is thereby comprised of three sections: a first adhesive section, a non-adhesive section and a second adhesive section, with the non-adhesive section defined by the perforated lines; step two 502, folding the crease, removing backing (if present) and contouring the tape to a caulkable object; step three 503, removing a perforated non-adhesive section before caulking is applied, step four 504, caulking the caulkable object; step five 505 removing the tape via peeling leaving behind a straight and uniform line of caulk.

It should be noted that step 505 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for caulking and removing the device are taught herein.

While the above description uses caulking as an exemplary embodiment, other forms of sealants, finishes and paint may be used in a similar manner, with the adhesive 122 having suitable characteristics to prevent penetration under the tape 110 during application. Similarly, the size (width and length) of the tape and of the perforated strip may be dependent on the purpose (e.g. indoor tiles or outdoor windows) as well as the intended use (e.g. caulking, painting, etc.).

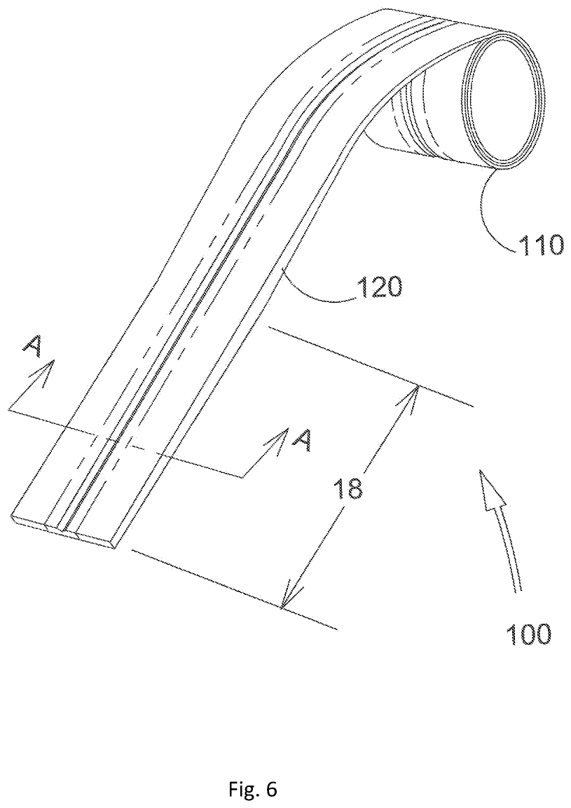

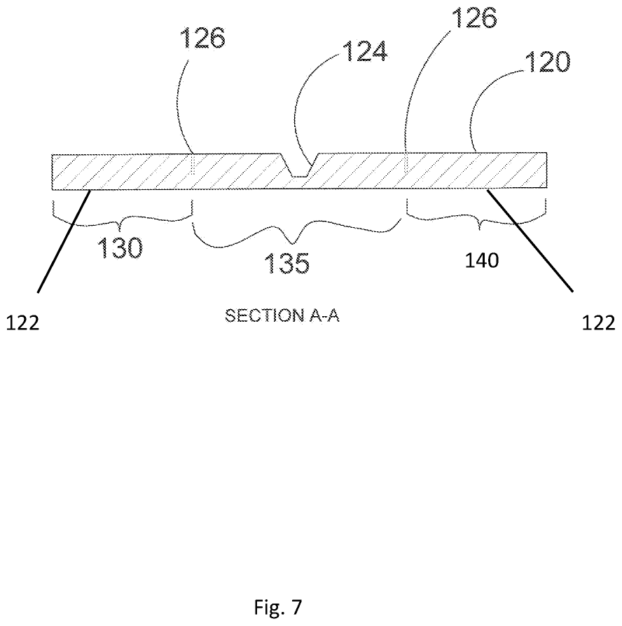

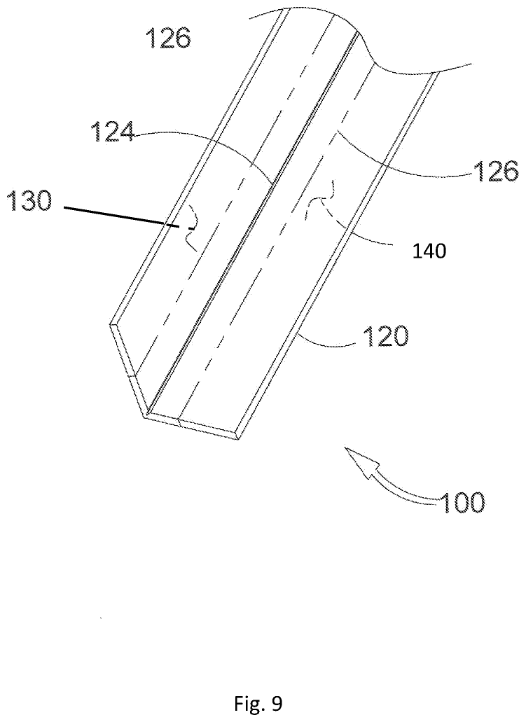

As will be demonstrated with greater specificity in FIG. 6-10, tape system 100 is primarily tape 110 which is formed using only a single layer. Single layer refers to the tape 110 itself. Single layer tape 110 is provided. Adhesive coating 122 is provided on a single side of single layer tape 110. As understood, adhesive 122 is on the underside of the tape system and is uses to secure the tape system into position. Single layer tape 110 has a measured length 18. A user will remove tape from the roll to expose adhesive coating 122 and apply tape system 100 onto a desired surface such that adhesive coating 122 to secure a system 100 in place as desired. Tape 110 is constructed and arranged with a pair of parallel perforations 126. Central indentation crease 124 is positioned in between each of perforation 126 equidistant from each of said perforations 126. A pair of sections being first adhesive section 130 and a second adhesive section 140 each placed distal from the center of tape 110 outward from perforations 126 until the outer edge of tape 110. First adhesive section 130 and a second adhesive section 140 separated be a non-adhesive section 135 which is removable via tearing along the perforations 126. This configuration provides Central section 135 that is void of any adhesive. A significant feature provides that central section 135 is removable when desired from system 100. Upon removing central section 135 when system 100 is secured to a surface, provides the desired exposed section 138 for application of caulking or other substances suitable for use in the system of the present invention.

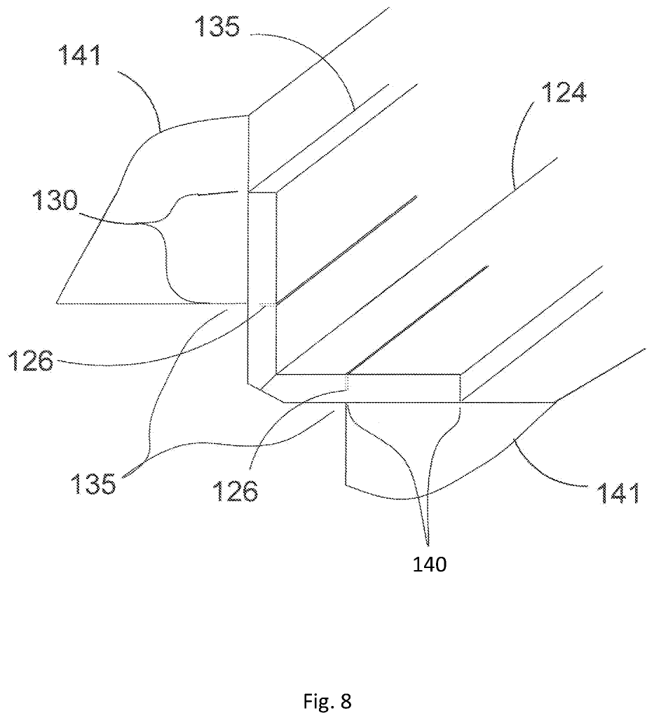

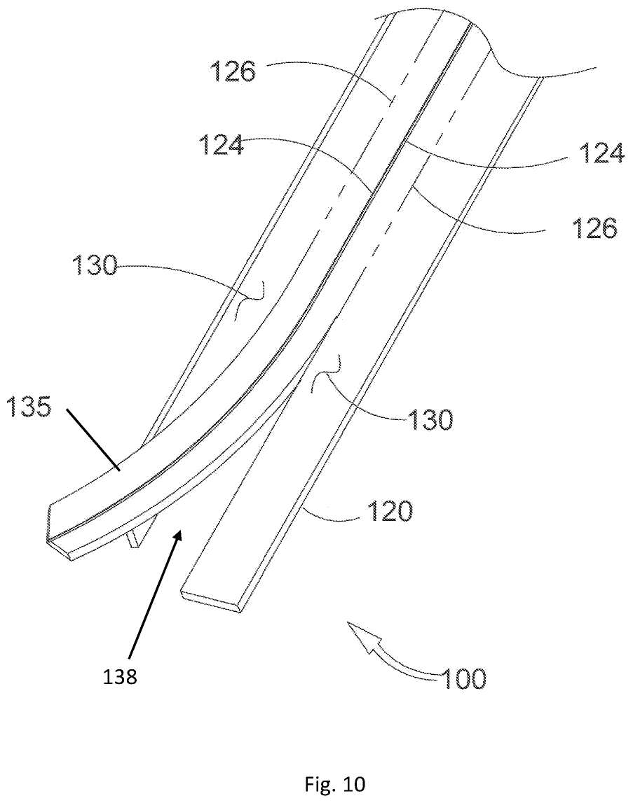

One particular use demonstrated in FIG. 8 provides each of adhesive sections 130 are secured to a surface 141. Section 135 is removed after tape system 100 is secured into position. Once center section 135 is removed, a central area 138, shown in FIG. 10, is exposed for deposition of caulking materials and the like. Central area 138 is configured as the receiving area for applying caulk.

As generally understood, adhesive 122 is a releasable adhesive.

The invention is used as follows:

Measure and unroll a desired section of tape;
Cut the unrolled section:
Fold the tape along central crease 124 of center section 135;
Separate approximately 1 inch of center section 135 long perforations 126;
Apply tape to desired surface;
Run fingers over each of first adhesive section 130 and a second adhesive section 140 to secure tape system into position;
Remove center section 135 completely to expose central area 138, central area 138 is the area configured to receive caulk;
Apply caulk in central area 138;
Draw finger along applied caulk at an angle leaving a layer of caulk to seal as desired. The drawing of one's finger will spill excess caulk (overspray) onto the upper/outer surface of the tape system above each of first adhesive section 130 and a second adhesive section 140;
Slowly and carefully lift each section of tape above each of first adhesive section 130 and a second adhesive section 140;

These steps leave a layer of caulk with straight and parallel borders.

The system of the present invention is a significant improvement over all known tape systems in that the single layer system, without any backing, is easier to use, less expensive to manufacture due to less materials utilized, and leaves uniform parallel borders once removed.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed:

1. A rapid caulk tape system comprising:
a tape provided in rolls,
said tape being only a single layer having a pair of parallel perforated lines running lengthwise along the center of the tape and a crease formed along a center of the tape between said perforated lines to facilitate positioning of the tape in a wall corner;
a removable central section defined by said parallel perforated lines;
and
said tape having a pressure-sensitive adhesive coating on a bottom surface of said tape, the pressure-sensitive adhesive coating located between said perforated line and an exterior perimeter of said tape such that said tape is thereby comprised of three sections: a first adhesive section, a non-adhesive section and a second adhesive section, with said removable non-adhesive center section defined by the perforated lines.

2. The rapid caulk tape system of claim 1, wherein said tape has a release coating on a top surface such that the pressure-sensitive adhesive on the bottom surface will releasably engage the release coating for manual separation of the tape when rolled upon itself.

3. The rapid caulk tape system of claim 1, wherein a crease is formed along a center of the tape between said perforated lines to facilitate positioning of the tape in a wall corner.

4. The rapid caulk tape system of claim 3, wherein said tape further includes evenly spaced slits along at least one exterior edge, the slits running perpendicular to said crease, to facilitate positioning of the tape along a curved surface.

5. The rapid caulk tape system of claim 1, wherein self-release properties of the pressure-sensitive adhesive of the tape is formulated to be able to peel away once caulk is added to an area exposed once a perforated removable center is removed.

6. The rapid caulk tape system of claim 5, wherein the tape once peeled away after said caulk is added, leaves behind a straight and uniform line of said caulk.

7. The rapid caulk tape system of claim 1, wherein the perforated lines are punch-pierced.

8. The rapid caulk tape system of claim 1, wherein the rolls are sequentially wound with said tape.

9. The rapid caulk tape system of claim 1, wherein the tape is able to be flexibly conformed to a wall corner.

10. The rapid caulk tape system of claim 9, wherein the wall corner a tile bath enclosure.

11. The rapid caulk tape system of claim 8, wherein the tape is planar when removed from said roll.

12. The rapid caulk tape system of claim 5, wherein the peel is provided via a manual-pull. of said perforated removable center

13. The rapid caulk tape system of claim 8, wherein the roll further includes a caulk smoothing tool removably attached to a starting end of said roll.

14. The rapid caulk tape system of claim 1, wherein the pressure-sensitive adhesive is run directly adjacent to said perforated lines.

15. A rapid caulk tape system comprising:
a tape provided in rolls,
said tape being only a single layer having a pair of parallel perforated lines running lengthwise along the center of the tape and a crease formed along a center of the tape between said perforated lines to facilitate positioning of the tape in a wall corner;
said tape having a pressure-sensitive adhesive coating on a bottom surface of said tape, the pressure-sensitive adhesive coating located between said perforated line and an exterior perimeter of said tape such that said tape is thereby comprised of three sections: a first adhesive section, a non-adhesive section and a second adhesive section, with the non-adhesive section defined by the perforated lines;
wherein the tape has a release coating on a top surface such that the pressure-sensitive adhesive on the bottom surface will releasably engage the release coating for manual separation of the tape when rolled upon itself;
wherein a crease is formed along a center of the tape to facilitate positioning of the tape in a wall corner;
wherein self-release properties of the pressure-sensitive adhesive of the tape is formulated to be able to peel away once the caulk is added to an area exposed once a perforated removable center is removed;
wherein the tape once peeled away leaves behind a straight and uniform line of the caulk;
wherein the rolls are sequentially wound with the tape;
wherein the pressure-sensitive adhesive comprises glue;
wherein the tape is able to be flexibly conformed to a caulkable object;
wherein the tape is substantially planar when removed from the roll; and
wherein the pressure-sensitive adhesive is run parallel and adjacent to the perforated lines.

16. The rapid caulk tape system of claim 15, further comprising set of instructions; and
wherein the rapid caulk tape system is arranged as a kit.

17. A method of use for the rapid caulk tape system, the method comprising the steps of:
providing a rapid caulk tape system of claim 1:
contouring said tape to a caulkable object or surface;
removing the non-adhesive center section via the perforated lines exposing a central area configured for receiving calking; and
caulking said exposed central area.

18. The method of claim 17, further comprising the step of removing said tape via peeling leaving behind a straight and uniform line of caulk.

19. A rapid caulk tape system consisting of:
a tape provided in rolls,
said tape being only a single layer having a pair of parallel perforated lines running lengthwise along the center of the tape and a crease formed along a center of the tape between said perforated lines to facilitate positioning of the tape in a wall corner;
said tape having a pressure-sensitive adhesive coating on a bottom surface of said tape, the pressure-sensitive adhesive coating located between said perforated line and an exterior perimeter of said tape such that said tape is thereby comprised of three sections: a first adhesive section, a non-adhesive section and a second adhesive section, with the non-adhesive section defined by the perforated lines;
wherein the tape has a release coating on a top surface such that the pressure-sensitive adhesive on the bottom surface will releasably engage the release coating for manual separation of the tape when rolled upon itself;
wherein a crease is formed along a center of the tape to facilitate positioning of the tape in a wall corner;
wherein self-release properties of the pressure-sensitive adhesive of the tape is formulated to be able to peel away once the caulk is added to an area exposed once a perforated removable center is removed;
wherein the tape once peeled away leaves behind a straight and uniform line of the caulk;
wherein the rolls are sequentially wound with the tape;
wherein the pressure-sensitive adhesive comprises glue;
wherein the tape is able to be flexibly conformed to a caulkable object;
wherein the tape is substantially planar when removed from the roll; and
wherein the pressure-sensitive adhesive is run parallel and adjacent to the perforated lines.
